(19) United States
(12) Patent Application Publication
(10) Pub. No.: US 2026/0188798 A1
(43) Pub. Date: Jul. 2, 2026

(54) SECONDARY BATTERY AND METHOD OF MANUFACTURING SECONDARY BATTERY

(71) Applicant: SAMSUNG SDI CO., LTD., Yongin-si (KR)

(72) Inventors: Hiroshi SEINO, Yongin-si (KR); Jeongchull AHN, Yongin-si (KR); Sanghyun KIM, Yongin-si (KR)

(21) Appl. No.: 19/344,783

(22) Filed: Sep. 30, 2025

(30) Foreign Application Priority Data
Jan. 2, 2025 (KR) 10-2025-0000301

(51) Int. Cl. H01M 50/121; H01M 10/052; H01M 10/054; H01M 10/0587; H01M 50/103; H01M 50/122; H01M 50/129; H01M 50/133; H01M 50/141; H01M 50/15; H01M 50/16; H01M 50/164; H01M 50/169; H01M 50/55

(52) U.S. Cl. CPC H01M 50/121; H01M 10/0587; H01M 50/103; H01M 50/122; H01M 50/129; H01M 50/133; H01M 50/141; H01M 50/15; H01M 50/16; H01M 50/164; H01M 50/169; H01M 50/55; H01M 10/052; H01M 10/054

(57) ABSTRACT

A secondary battery includes a case body having an opening formed therein. An electrode assembly is accommodated in the case body and comprising a first electrode, a separator, and a second electrode. A case cover is coupled the case body to cover the opening. At least a portion of each of the case body and the case cover comprise a polymer layer comprising a resin material, and a water vapor transmission rate of the polymer layer may be less than or equal to 20 g/m²·day under conditions of 40° C. and 90% relative humidity.

### CROSS-REFERENCE TO RELATED APPLICATION

The present application claims priority to and the benefit of Korean Application No. 10-2025-0000301, filed on Jan. 2, 2025, in the Korean Intellectual Property Office, the entire disclosure of which is incorporated by reference herein.

### BACKGROUND

### Field

The present disclosure relates to a secondary battery and a method of manufacturing the secondary battery.

### Description of the Related Art

Unlike primary batteries that are not designed to be recharged, secondary (or rechargeable) batteries are batteries can be repeatedly discharged and recharged. Low-capacity secondary batteries are used in portable, small electronic devices, such as smart phones, feature phones, notebook computers, digital cameras, and camcorders. Large-capacity secondary batteries are widely used as power sources for driving motors in hybrid vehicles and electric vehicles and for storing power (e.g., home and/or utility scale power storage). A secondary battery generally includes an electrode assembly including a positive electrode and a negative electrode, a case accommodating the electrode assembly, and electrode terminals connected to the electrode assembly.

Regarding portable electronic devices such as smart phones, continuous efforts are being made to develop secondary batteries that are detachable so that a user may readily replace the secondary battery. To minimize deformation of an exterior of a case during detachment and attachment of the secondary battery, a stainless-steel material has been proposed for the case of the secondary battery. However, when a stainless-steel case is used, the weight of the battery increases.

The above information disclosed in this section is for enhancement of understanding of the background of the present disclosure. It may contain information that does not constitute related or prior art.

### SUMMARY

An object of the present disclosure is to provide a secondary battery, and a method and apparatus for manufacturing the secondary battery, that address the above-described problems.

These and other aspects and features of the present disclosure will be described in or will be apparent from the following description of embodiments of the present disclosure.

In accordance with some embodiments of the present disclosure, a secondary battery includes a case body having an opening formed therein, an electrode assembly accommodated in the case body, with the electrode assembly including a first electrode, a separator, and a second electrode, and a case cover covering the opening of the case body. At least a portion of each of the case body and the case cover includes a polymer layer including a resin material, and a water vapor transmission rate of the polymer layer may be less than or equal to 20 g/m²·day under conditions of 40° C. and 90% relative humidity.

According to some embodiments of the present disclosure, a dimethyl carbonate (DMC) transmission rate of the polymer layer may be less than or equal to 20 g/m²·day under conditions of 40° C.

According to some embodiments of the present disclosure, a density of the polymer layer may be less than or equal to 1.5 g/cm³.

According to some embodiments of the present disclosure, a thickness of the polymer layer may be 100 μm to 150 μm.

According to some embodiments of the present disclosure, at least a portion of the polymer layer may include at least one of oriented polypropylene (OPP), cast polypropylene (CPP), CPP with aluminum deposition (CPP Al), polyetheretherketone (PEEK), liquid crystal polymer (LCP), polytetrafluoroethylene (PTFE), perfluoroalkoxy (PFA), fluorinated ethylene propylene (FEP), and polychlorotrifluoroethylene (PCTFE).

According to some embodiments of the present disclosure, the polymer layer may include a first polymer layer facing the electrode assembly and a second polymer layer disposed on the first polymer layer and exposed externally.

According to some embodiments of the present disclosure, at least a portion of the first polymer layer may include polypropylene (PP), and at least a portion of the second polymer layer may include at least one of PEEK, CPP Al, LCP, PTFE, and PCTFE.

According to some embodiments of the present disclosure, 10 wt % to 20 wt % of the first polymer layer may include an inorganic compound.

According to some embodiments of the present disclosure, the polymer layer may further include a third polymer layer disposed between the first polymer layer and the second polymer layer.

According to some embodiments of the present disclosure, at least a portion of the first polymer layer may include PP, at least a portion of the second polymer layer may include at least one of PEEK and polyethylene terephthalate (PET), and at least a portion of the third polymer layer may include PTFE.

According to some embodiments of the present disclosure, an electrode terminal electrically connected to the first electrode may protrude from aside surface of the case body.

According to some embodiments of the present disclosure, the case body may include a receiving portion in which the electrode assembly is accommodated and a flange portion that surrounds the receiving portion, and the case cover may be disposed such that at least a portion of the case that faces the flange portion of the case body.

In accordance with some embodiments of the present disclosure, a method of manufacturing a secondary battery includes providing an electrode assembly including a first electrode, a separator, and a second electrode, providing a case body having an opening, inserting the electrode assembly into the case body, and coupling a case cover to the case body to cover the opening. At least a portion of each of the case body and the case cover includes a polymer layer including a resin material, and a water vapor transmission rate of the polymer layer may be less than or equal to 20 g/m²·day under conditions of 40° C. and 90% relative humidity.

According to some embodiments of the present disclosure, a DMC transmission rate of the polymer layer may be less than or equal to 20 g/m²·day under conditions of 40° C.

According to some embodiments of the present disclosure, a density of the polymer layer may be less than or equal to 1.5 g/cm³.

According to some embodiments of the present disclosure, the polymer layer may include a first polymer layer facing the electrode assembly and a second polymer layer disposed on the first polymer layer and exposed externally, at least a portion of the first polymer layer may include PP, and at least a portion of the second polymer layer may include at least one of PEEK, CPP Al, LCP, PTFE, and PCTFE.

According to some embodiments of the present disclosure, 10 wt % to 20 wt % of the first polymer layer may include an inorganic compound.

According to some embodiments of the present disclosure, an electrode terminal may protrude from a side surface of the case body, and the inserting may include electrically connecting the first electrode to the electrode terminal.

According to some embodiments of the present disclosure, the case body may include a receiving portion in which the electrode assembly is accommodated and a flange portion that surrounds the receiving portion, and the coupling may include disposing at least a portion of the flange portion of the case body to face the case cover and coupling the case body and the case cover by thermal welding or laser welding. According to some embodiments of the present disclosure, the case body may be formed by vacuum forming or deep drawing.

According to some embodiments of the present disclosure, at least a portion of a case of the secondary battery is formed of a polymer layer including a resin material and a water vapor transmission rate, electrolyte transmission rate, and thickness of the polymer layer are effective, weight reduction of the battery can be achieved without impairing battery characteristics.

According to some embodiments of the present disclosure, because the case of the secondary battery is formed of a double-layer or triple-layer polymer layer and a material and/or a thickness of each layer are differentiated, the water vapor transmission rate, electrolyte transmission rate, and thickness of the polymer layer can be effective.

According to some embodiments of the present disclosure, because an inorganic compound is added to the polymer layer within a predetermined range, the water vapor transmission rate and electrolyte transmission rate of the polymer layer can be reduced.

However, aspects and features of the present disclosure are not limited to those described above, and other aspects and features not mentioned will be clearly understood by a person skilled in the art from the detailed description below.

### BRIEF DESCRIPTION OF DRAWINGS

The drawings illustrate embodiments of the present disclosure and further describe aspects and features of the present disclosure together with the detailed description of the present disclosure. The present disclosure is not limited to the embodiments depicted in the drawings.

FIG. 1 is a perspective view of a secondary battery according to embodiments of the present disclosure.

FIG. 2 is an exploded perspective view of a secondary battery according to embodiments of the present disclosure.

FIG. 3 is a cross-sectional view of an example of a polymer layer according to embodiments of the present disclosure.

FIG. 4 is a cross-sectional view of an example of a polymer layer according to embodiments of the present disclosure.

FIG. 5 is a cross-sectional view of an example of a polymer layer according to embodiments of the present disclosure.

FIG. 6 is a cross-sectional view of an example of a polymer layer according to embodiments of the present disclosure.

FIG. 7 is a flowchart of a method of manufacturing a secondary battery according to embodiments of the present disclosure.

FIG. 8 illustrates a method of manufacturing a secondary battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, sizes and relative sizes of areas shown in the drawings may be exaggerated for clarity of description. That is, the sizes shown in the drawings are merely for ease of understanding and are not limited thereto. Further, like reference numerals throughout the specification refer to like elements.

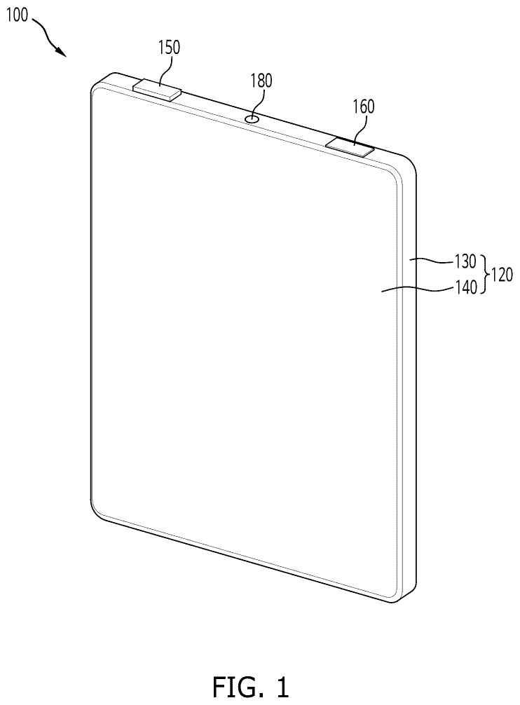

FIG. 1 is a perspective view of a secondary battery 100 according to embodiments of the present disclosure. The secondary battery 100 may include a case 120, electrode terminals 150 and 160, and an electrolyte injection hole 180.

The case 120 forms an exterior of the secondary battery 100 and provides a space accommodating the electrode assembly. The case 120 may include a case body 130 and a case cover 140. The case body 130 may define an internal space accommodating the electrode assembly and an electrolyte. The case 120 may be sealed when the case body 130 and the case cover 140 are coupled together.

The electrode terminals 150 and 160 may be disposed on one side of the case 120. For example, a first electrode terminal 150 and/or a second electrode terminal 160 may protrude from one side of the case body 130. When the first electrode terminal 150 is a positive electrode terminal, the second electrode terminal 160 may be a negative electrode terminal, and vice versa. Each of the first electrode terminal 150 and the second electrode terminal 160 may be implemented in various forms, such as a plate or a rivet. And the form and/or size of electrode terminals 150 and 160 are not limited to those illustrated. In embodiments where at least a portion of the case 120 is made of a metal, the case 120 itself may serve as an electrode terminal.

The electrolyte injection hole 180 may be formed in one side of the case 120. The electrolyte injection hole 180 may be a through-hole extending through the case 120. After an electrolyte is injected into the case 120 through the electrolyte injection hole 180, the electrolyte injection hole 180 may be sealed by a sealing member.

The secondary battery 100 may be, for example, a lithium secondary battery or a sodium secondary battery. However, the scope of the present disclosure is not limited with respect to the type of secondary battery. Rather, the secondary battery 100 may by any type of battery capable of repeatedly supplying electricity through charge and discharge.

The configuration illustrated in FIG. 1 for the secondary battery 100 is merely an example. In other embodiments of the present disclosure, configurations other than those illustrated may be further included, and some configurations may be omitted. Further, the shapes and positional relationships of the components of the secondary battery 100 illustrated in FIG. 1 may be variously changed.

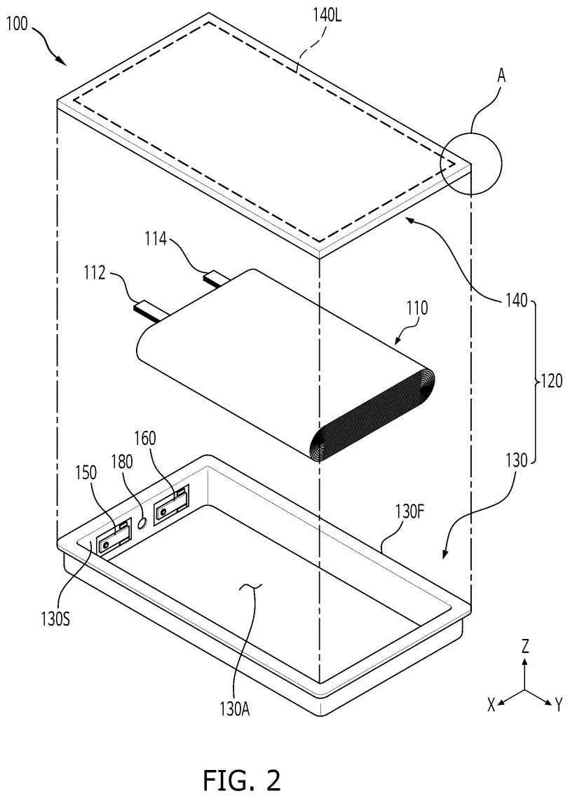

FIG. 2 is an exploded perspective view of the secondary battery 100 according to embodiments of the present disclosure. As depicted, an electrode assembly 110 may be accommodated inside the case 120 of the secondary battery 100.

The electrode assembly 110 may include a first electrode, a second electrode, and a separator interposed between the electrodes. In particular, the first electrode and the second electrode may be wound with the insulative separator interposed between the electrode. However, the present disclosure is not limited to such a configuration. The electrode assembly may alternatively be configured such that a plurality of sheet-like first electrodes and second electrodes are alternately stacked with the separator interposed therebetween.

The first electrode may include a first substrate, a first coated portion where an active material is disposed on the first substrate, and a first uncoated portion where the active material is not disposed and the substrate is exposed. In an embodiment, the first electrode may function as a positive electrode.

The second electrode may include a second substrate, a second coated portion where an active material is disposed on the second substrate, and a second uncoated portion where the active material is not disposed and the substrate is exposed. In an embodiment, the second electrode may function as a negative electrode.

The separator may allow movement of lithium ions while preventing a short circuit between the first electrode and the second electrode. The separator may be made of, for example, a polyethylene film, a polypropylene film, a polyethylene-polypropylene film, or the like. But the present disclosure is not limited to these examples.

A first electrode tab 112 electrically connected to the first uncoated portion may be formed or connected at one side of the first electrode. For example, the first electrode tab 112 may be a substrate tab that is a part of the uncoated portion. Additionally or alternatively, a plurality of first electrode tabs 112 may be formed or connected to one side of the first electrode. Each of the first electrode tabs 112 may protrude to a specific position of the electrode assembly 110, and the first electrode tabs 112 may be connected together to form a lead tab.

A second electrode tab 114 electrically connected to the second uncoated portion may be formed or connected to one side of the second electrode. For example, the second electrode tab 114 may be a substrate tab that is a part of the uncoated portion. Additionally or alternatively, a plurality of second electrode tabs 114 may be formed or connected to one side of the second electrode. Each of the second electrode tabs 114 may protrude to a specific position of the electrode assembly 110, and the plurality of second electrode tabs 114 may be connected together to form a lead tab.

A position at which the first electrode tab 112 protrudes from the electrode assembly 110 may differ from a position at which the second electrode tab 114 protrudes from the electrode assembly 110. For example, the first electrode tab 112 and the second electrode tab 114 may protrude from the same surface of the electrode assembly 110 while being spaced apart from each other. Alternatively, the first electrode tab 112 may protrude from a first surface of the electrode assembly 110, and the second electrode tab 114 may protrude from a second surface of the electrode assembly 110.

The case 120 may include the case body 130 and the case cover 140. As a specific example, the case body 130 may be a substantially rectangular-parallelepiped container having an opening in one surface. The electrode assembly 110 may be inserted into the case body 130 through the opening.

Electrode terminals 150 and 160 may be formed on a side surface 130S of the case body 130. The side surface 130S may be a long side surface or a short side surface other than a bottom surface of the case body 130. In the embodiment depicted in FIG. 2, the first electrode terminal 150 and the second electrode terminal 160 are illustrated as being formed on the same side surface 130S of the case body 130, but the present disclosure is not limited to such a configuration. The first electrode terminal 150 and the second electrode terminal 160 may be formed on different surfaces of the case body 130.

The case body 130 may include a receiving portion 130A in which the electrode assembly 110 is accommodated. The electrode assembly 110 may be disposed such that each of the first electrode tab 112 and the second electrode tab 114 faces the first electrode terminal 150 and the second electrode terminal 160 formed in the case body 130, respectively. The first electrode tab 112 and the second electrode tab 114 may be connected to the first electrode terminal 150 and the second electrode terminal 160, respectively. The first electrode tab 112 may form a current flow path between the first electrode and the first electrode terminal 150, and the second electrode tab 114 may form a current flow path between the second electrode and the second electrode terminal 160.

The case body 130 may include a flange portion 130F surrounding the receiving portion 130A. The case cover 140 may be disposed such that at least a portion of the cover 140 faces the flange portion 130F of the case body 130. And the case cover 140 may be coupled to the case body 130. The case cover 140 may be a plate-shaped member having a shape corresponding to a shape of the case body 130. While the case cover 140 is disposed on the flange portion 130F of the case body 130, the case cover 140 may be welded to the case body 130 along a coupling line 140L. Although the case body 130 and the case cover 140 may be coupled by thermal welding or laser welding, the coupling method is not limited thereto and may include, for example, heat fusion.

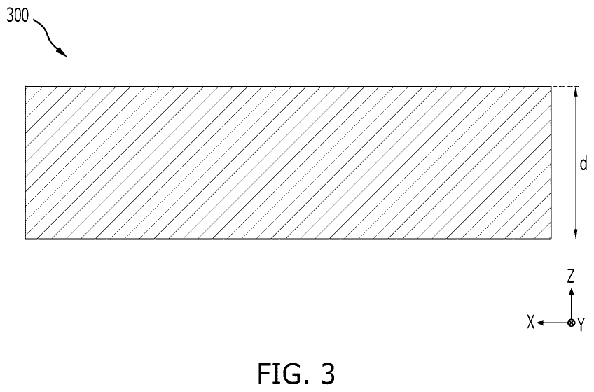

At least a portion of each of the case body 130 and the case cover 140 may include a polymer layer that includes a resin material. The polymer layer may be made of a material having a water vapor transmission rate less than a predetermined value. Further, the polymer layer may be made of a material having an electrolyte transmission rate less than a predetermined value. Specific examples of a polymer layer that constitutes the case body 130 and the case cover 140 will be described in detail below with reference to FIGS. 3 through 6.

In an embodiment, the case body 130 and the case cover 140 including the polymer layer may be formed by vacuum forming or deep drawing. In FIG. 2, the case body 130 and the case cover 140 are illustrated as separate components, but the present disclosure is not limited thereto. For example, the case body 130 and the case cover 140 may be integrally formed.

In FIG. 2, the case 120 is a prismatic case, and the secondary battery 100 is a prismatic secondary battery. However, the scope of the present disclosure is not limited in this regard. The secondary battery 100 may be a secondary battery of any shape, such as a prismatic, cylindrical, or pouch type.

FIG. 3 is a cross-sectional view illustrating an example of a polymer layer 300 according to embodiments of the present disclosure. FIG. 3 illustrates a longitudinal cross-section taken along area A of FIG. 2. The polymer layer 300 constitutes at least a portion of the case of the secondary battery and may be formed as a single layer.

The polymer layer 300 may be made of a material having a water vapor transmission rate less than a predetermined value. If the water vapor transmission rate of the polymer layer 300 exceeds the predetermined value, then water vapor introduced into the interior of the secondary battery through the case may react with an electrolyte. In such a case, the secondary battery may swell, thereby deteriorating battery characteristics. In specific examples, the polymer layer 300 may be made of a material having a water vapor transmission rate of less than or equal to 20 g/m²·day under conditions of 40° C. and 90% relative humidity.

The polymer layer 300 may be made of a material having an electrolyte transmission rate less than a predetermined value. If the electrolyte transmission rate of the polymer layer 300 exceeds the predetermined value, then an electrolyte inside the secondary battery may permeate the case and be released to outside of the case. Thus, battery characteristics may deteriorate due to loss of the electrolyte from the secondary battery. As a specific example, the polymer layer 300 may be made of a material having a dimethyl carbonate (DMC) transmission rate of less than or equal to 20 g/m²·day under conditions of 40° C.

The polymer layer 300 may be made of a material having a density less than a predetermined value, thereby reducing the weight of the secondary battery. As a specific example, the polymer layer 300 may be made of a material and structure having a density of less than or equal to 1.5 g/cm³. But the present disclosure is not limited to this example.

At least a portion of the polymer layer may include at least one of oriented polypropylene (OPP), cast polypropylene (CPP), CPP with aluminum deposition (CPP Al), polyetheretherketone (PEEK), liquid crystal polymer (LCP), polytetrafluoroethylene (PTFE), perfluoroalkoxy (PFA), fluorinated ethylene propylene (FEP), and polychlorotrifluoroethylene (PCTFE).

Table 1 below presents experimental results for a water vapor transmission rate and an electrolyte transmission rate measured according to a thickness of the single-layer polymer layer 300. The experimental results were measured under conditions of 40° C., 90% relative humidity, and 1 atm based on test standard JIST 8030.

TABLE 1

| | | | | Water Vapor | DMC |
|---|---|---|---|---|---|
| | Material of | | | Transmission | Transmission |
| | Polymer | Thickness | Density | Rate | Rate |
| | Layer | (μm) | (g/cm³) | (g/m² · day) | (g/m² · day) |
| First | PP | 100 | 0.90 | 3.0 | 23.8 |
| Embodiment | | | | | |
| Second | PP | 150 | 0.90 | 2.0 | 15.8 |
| Embodiment | | | | | |

In Table 1, the term “water vapor transmission rate” refers to an amount of water vapor transmitted per unit area for a predetermined time under conditions of 40° C. and 90% relative humidity. The term “DMC transmission rate” may refer to an amount of DMC transmitted per unit area for a predetermined time under conditions of 40° C.

Referring to Table 1, the water vapor transmission rate and the DMC transmission rate may be inversely proportional to a thickness of the polymer layer 300. That is, as the thickness of the polymer layer 300 increases, the water vapor transmission rate and the DMC transmission rate may decrease. However, when the thickness of the polymer layer 300 increases, a weight of the case of the secondary battery also increases. Considering the weight of the case, the water vapor transmission rate, and the DMC transmission rate, the thickness of the polymer layer 300 in embodiments of the present disclosure may be 100 μm or greater and 150 μm or less, i.e., 100 μm to 150 μm. With such a configuration, by forming at least a portion of the case of the secondary battery with the polymer layer 300 including a resin material and optimizing the water vapor transmission rate, electrolyte transmission rate, and thickness of the polymer layer 300, weight reduction of the battery can be achieved without impairing battery characteristics.

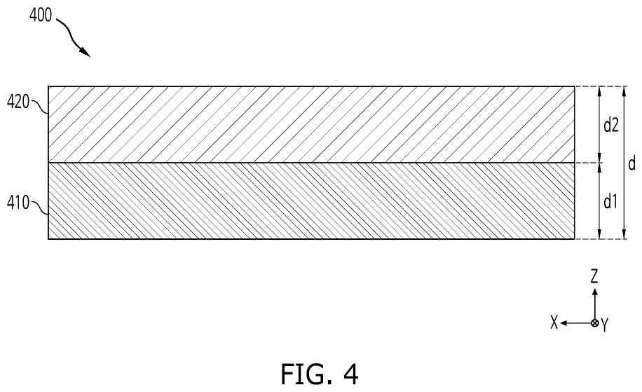

FIG. 4 is a cross-sectional view of an example of a polymer layer 400 according to some embodiments of the present disclosure. FIG. 4 illustrates a longitudinal cross-section taken along area A of FIG. 2. As illustrated, the polymer layer 400 that constitutes at least a portion of the case of the secondary battery has a double-layer structure.

The double-layer polymer layer 400 may include a first polymer layer 410 facing the electrode assembly and a second polymer layer 420 disposed on the first polymer layer 410 and exposed externally. The first polymer layer 410 may be in direct contact with the electrode assembly and/or the electrolyte. At least a portion of the first polymer layer 410 may include PP. In addition. At least a portion of the second polymer layer may include at least one of PEEK, CPP Al, LCP, PTFE, and PCTFE.

Table 2 below presents experimental results for a water vapor transmission rate and an electrolyte transmission rate of the double-layer polymer layer 400. The experimental results were measured under conditions of 40° C., 90% relative humidity, and 1 atm based on test standard JIST 8030. “T” stands for thickness.

TABLE 2

| | First | | second | | | | Water Vapor | DMC |
|---|---|---|---|---|---|---|---|---|
| | Polymer Layer | | polymer layer | | | | Transmission | Transmission |
| | | T1 | | T2 | T | Density | Rate | Rate |
| | Material | (μm) | Material | (μm) | (μm) | (g/cm³) | (g/m² · day) | (g/m² · day) |
| First | PP | 25 | PEEK | 25 | 50 | 1.15 | 7.0 | 24.9 |
| Comparative | | | | | | | | |
| Example | | | | | | | | |
| First | PP | 50 | PEEK | 50 | 100 | 1.15 | 3.5 | 12.4 |
| Embodiment | | | | | | | | |
| Second | PP | 50 | CPP AL | 50 | 100 | 0.91 | 1.6 | 12.2 |
| Embodiment | | | deposition | | | | | |
| Third | PP | 50 | LCP | 50 | 100 | 1.25 | 1.6 | 11.9 |
| Embodiment | | | | | | | | |
| Fourth | PP | 50 | PTFE | 50 | 100 | 1.54 | 3.5 | 19.4 |
| Embodiment | | | | | | | | |
| Fifth | PP | 50 | PCTFE | 50 | 100 | 1.51 | 1.6 | 18.8 |
| Embodiment | | | | | | | | |
| Sixth | PP | 75 | PEEK | 75 | 150 | 1.15 | 2.3 | 8.3 |
| Embodiment | | | | | | | | |

Referring to Table 2, when the polymer layer 400 is configured as a double layer, the water vapor transmission rate and the DMC transmission rate are generally reduced as compared to when the polymer layer is configured as a single layer (for example, the first and second embodiments in Table 1). But the density tends to increase. That is, by configuring the case of the secondary battery with the double-layer polymer layer 400 and differentiating a material of each layer, the water vapor transmission rate, electrolyte transmission rate, and thickness of the polymer layer 400 can be set to produce the best effect.

The first comparative example and the first embodiment in Table 2 are experimental results obtained by setting materials and thickness ratios of each of the first polymer layer 410 and the second polymer layer 420 to be the same while varying only an overall thickness T. Specifically, the first comparative example represents a case in which the thickness T1 of the first polymer layer 410 is 25 μm, the thickness T2 of the second polymer layer 420 is 25 μm, and the overall thickness of the polymer layer 400 is 50 μm. The first embodiment represents a case in which the thickness T1 of the first polymer layer 410 is 50 μm, the thickness T2 of the second polymer layer 420 is 50 μm, and the overall thickness of the polymer layer 400 is 100 μm. In both the first comparative example and the first embodiment, the water vapor transmission rate is less than or equal to 20 g/m²·day. But in the first comparative example the electrolyte transmission rate exceeds 20 g/m²·day. Thus, in embodiments of the present disclosure, the thickness of the polymer layer 400 may be greater than 50 μm, for example, 100 μm or greater and 150 μm or less.

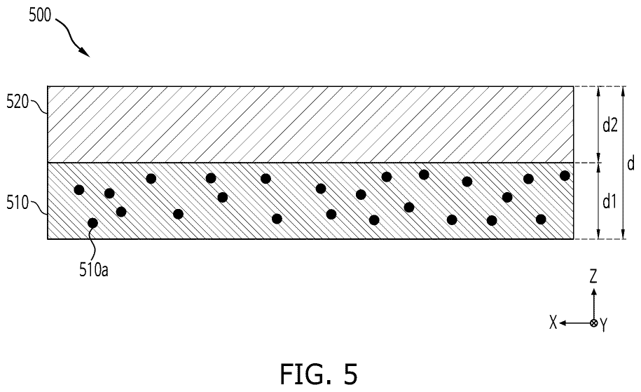

FIG. 5 is a cross-sectional view of an example of a polymer layer 500 according to some embodiments of the present disclosure. FIG. 5 illustrates a longitudinal cross-section taken along area A of FIG. 2. The polymer layer 500 that constitutes at least a portion of the case of the secondary battery may have a double-layer structure including a first polymer layer 510 and a second polymer layer 520. Here, the first polymer layer 510 faces the electrode assembly, and the second polymer layer 520 is disposed on the first polymer layer 510 and exposed externally.

The first polymer layer 510 may include an inorganic compound 510a. In this case, a gas permeation path through the polymer layer 500 may be elongated by particles of the inorganic compound 510a, thereby reducing a water vapor transmission rate. However, when the inorganic compound 510a is included in the first polymer layer 510 in excess of a predetermined ratio, it may be harder to form the case of the secondary battery. Accordingly, the inorganic compound 510a may be included in the first polymer layer 510 within a predetermined ratio range.

Table 3 below presents experimental results for a water vapor transmission rate and an electrolyte transmission rate of the double-layer polymer layer 500. The experimental results were measured under conditions of 40° C., 90% relative humidity, and 1 atm based on test standard JIST 8030. In addition, alumina (Al₂O₃) was added to the first polymer layer of each of the first through third embodiments at a predetermined ratio. “T” stands for thickness.

TABLE 3

| | First | | Second | | | | | Water Vapor | DMC |
|---|---|---|---|---|---|---|---|---|---|
| | Polymer Layer | | Polymer Layer | | | | | Transmission | Transmission |
| | | T1 | | T2 | T | Density | Additive | Rate | Rate |
| | Material | (μm) | Material | (μm) | (μm) | (g/cm³) | (wt %) | (g/m² · day) | (g/m² · day) |
| First | PP | 50 | PEEK | 50 | 100 | 1.15 | X | 3.5 | 12.4 |
| Comparative | | | | | | | | | |
| Example | | | | | | | | | |
| First | PP | 50 | PEEK | 50 | 100 | 1.30 | Al₂O₃ | 3.4 | 11.3 |
| Embodiment | | | | | | | 10% | | |
| Second | PP | 50 | PEEK | 50 | 100 | 1.46 | Al₂O₃ | 3.2 | 10.1 |
| Embodiment | | | | | | | 20% | | |
| Third | PP | 50 | PEEK | 50 | 100 | 1.61 | Al₂O₃ | 3.1 | 35.5 |
| Embodiment | | | | | | | 30% | | |

Referring to Table 3, when alumina (Al₂O₃) is included in the first polymer layer 510 at a predetermined ratio (as in the first embodiment and the second embodiment), the water vapor transmission rate and the DMC transmission rate are reduced compared with a case where alumina (Al₂O₃) is not included (as in the first comparative example). However, when alumina (Al₂O₃) is added to the first polymer layer 510 at a ratio of 30% (as the third embodiment), the DMC transmission rate rather increases sharply. This phenomenon may be because the result of the alumina (Al₂O₃) particles being not uniformly distributed in the first polymer layer 510 due stemming from the first polymer layer 510 being harder to form. In addition, the density of the polymer layer 500 may increase due to the inorganic compound 510a included in the first polymer layer 510. As such, in embodiments of the present disclosure, the first polymer layer 510 may include the inorganic compound 510a at a ratio of less than 30%, for example, 10% or greater and 20% or less.

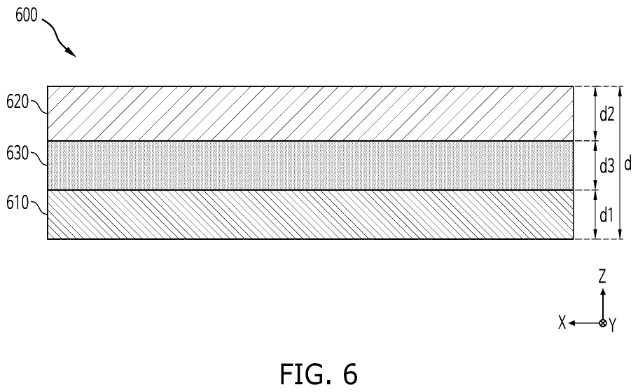

FIG. 6 is a cross-sectional view of a polymer layer 600 according to some embodiments of the present disclosure. FIG. 6 illustrates a longitudinal cross-section taken along area A of FIG. 2. As illustrated, the polymer layer 600 that constitutes at least a portion of the case of the secondary battery may have a triple-layer structure including a first polymer layer 610, a second polymer layer 620, and a third polymer layer 630. Here, the first polymer layer 610 faces the electrode assembly, the second polymer layer 620 is disposed on the first polymer layer 610 and may be exposed externally, and the third polymer layer 630 may be disposed between the first polymer layer 610 and the second polymer layer 620.

Table 4 below presents experimental results for a water vapor transmission rate and an electrolyte transmission rate of the triple-layer polymer layer 600. The experimental results may have been measured under conditions of 40° C., 90% relative humidity, and 1 atm based on test standard JIST 8030.

TABLE 4

| | First | | Second | | Third | | | | Water Vapor | DMC |
|---|---|---|---|---|---|---|---|---|---|---|
| | Polymer Layer | | Polymer Layer | | Polymer Layer | | | | Transmission | Transmission |
| | | T1 | | T2 | | T3 | T | Density | Rate | Rate |
| | Material | (μm) | Material | (μm) | Material | (μm) | (μm) | (g/cm³) | (g/m² · day) | (g/m² · day) |
| First | PP | 40 | PEEK | 30 | PTFE | 30 | 100 | 1.43 | 3.60 | 14.3 |
| Embodiment | | | | | | | | | | |
| Second | PP | 30 | PEEK | 30 | PTFE | 40 | 100 | 1.56 | 3.70 | 13.5 |
| Embodiment | | | | | | | | | | |
| Third | PP | 25 | PEEK | 25 | PTFE | 50 | 100 | 1.66 | 3.75 | 13.7 |
| Embodiment | | | | | | | | | | |
| Fourth | PP | 40 | PET | 30 | PTFE | 30 | 100 | 1.43 | 3.60 | 14.3 |
| Embodiment | | | | | | | | | | |

The experimental results shown in Table 4 were obtained by varying a material and/or a thickness of each of the first polymer layer 610, the second polymer layer 620, and the third polymer layer 630 while maintaining an overall thickness T of the polymer layer 600 at 100 μm. It can be seen that as the material and/or the thickness of the first polymer layer 610, the second polymer layer 620, and the third polymer layer 630 change, a density, a water vapor transmission rate, and a DMC transmission rate of the polymer layer 600 change. As such, the water vapor transmission rate, electrolyte transmission rate, and thickness of the polymer layer 600 can be improved.

In FIGS. 3 through 6, examples in which the polymer layer is configured as a single layer, a double layer, and a triple layer are illustrated. However, the structure of the polymer layer is not limited thereto and may be configured with four or more layers.

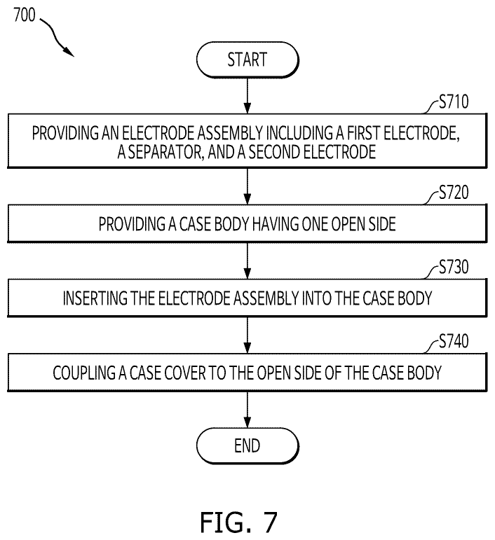

FIG. 7 is a flowchart illustrating a method 700 of manufacturing a secondary battery to some embodiments of the present disclosure. The method 700 of manufacturing a secondary battery may start with providing an electrode assembly including a first electrode, a separator, and a second electrode (S710). Next, a case body having an opening may be provided (S720). The case body may include a receiving portion in which the electrode assembly is accommodated and a flange portion that surrounds the receiving portion. The case body may be formed by vacuum forming or deep drawing.

Next, the electrode assembly may be inserted into the case body (S730). Electrode terminals may protrude from a side surface of the case body. The first electrode of the electrode assembly may be electrically connected to the electrode terminals.

Next, a case cover may be coupled to the case body to cover the opening (S740). For example, at least a portion of the flange portion of the case body may be disposed to face the case cover. In addition, the case body and the case cover may be coupled by thermal welding or laser welding. At least a portion of each of the case body and the case cover may include a polymer layer including a resin material.

The polymer layer that constitutes at least a portion of each of the case body and the case cover may have a water vapor transmission rate that is less than a predetermined value. As a specific example, the water vapor transmission rate of the polymer layer may be less than or equal to 20 g/m²·day under conditions of 40° C. and 90% relative humidity.

The polymer layer that constitutes at least a portion of each of the case body and the case cover may have a DMC transmission rate not greater than a predetermined value. As a specific example, the DMC transmission rate of the polymer layer that is less than or equal to 20 g/m²·day under conditions of 40° C.

A density of the polymer layer that constitutes at least a portion of each of the case body and the case cover may be less than or equal to 1.5 g/cm³. In addition, a thickness of the polymer layer may be 100 μm or greater and 150 μm or less. As a specific example, at least a portion of the polymer layer may include at least one of OPP, CPP, CPP Al, PEEK, LCP, PTFE, PFA, FEP, and PCTFE.

The polymer layer may include a first polymer layer facing the electrode assembly and a second polymer layer disposed on the first polymer layer and exposed externally. Here, at least a portion of the first polymer layer may include PP. In addition, at least a portion of the second polymer layer may include at least one of PEEK, CPP Al, LCP, PTFE, and PCTFE. Further, the first polymer layer may include 10% to 20% of an inorganic compound.

The polymer layer may further include a third polymer layer disposed between the first polymer layer and the second polymer layer. In this configuration, at least a portion of the first polymer layer may include PP, at least a portion of the second polymer layer may include at least one of PEEK and PET, and at least a portion of the third polymer layer may include PTFE.

The flowchart of FIG. 7 and the above description are merely examples of the present disclosure, and the scope of the present disclosure is not limited to the flowchart of FIG. 7 and the above description. For example, one or more steps of the flowchart and the above description may be added, changed, or deleted, an order of one or more steps may be changed, and one or more steps may be performed simultaneously.

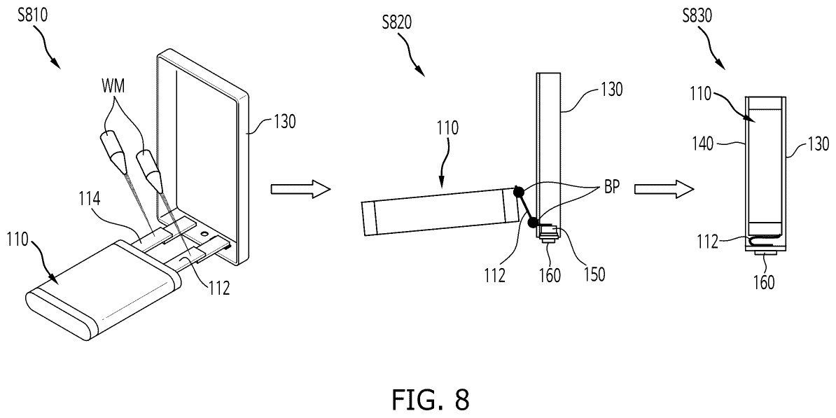

FIG. 8 is illustrates a method of manufacturing a secondary battery according to embodiments of the present disclosure. FIG. 8 illustrates, in detail, step S730 of FIG. 7. The electrode assembly 110 may be electrically connected to the electrode terminals 150 and 160 (S810). For example, the first electrode tab 112 and the second electrode tab 114 protruding from the electrode assembly 110 may be connected to the first electrode terminal 150 and the second electrode terminal 160 formed in the case body 130, respectively. Each of the first electrode tab 112 and the second electrode tab 114 may be directly connected to the first electrode terminal 150 and the second electrode terminal 160 or may be connected thereto via another component such as a strip terminal. Each of the first electrode tab 112 and the second electrode tab 114 may be welded (WM) to the first electrode terminal 150 and the second electrode terminal 160, respectively. But the present disclosure is not limited to this configuration.

Next, the electrode assembly 110 may be inserted through the opening of the case body 130 (S820). At this time, as the electrode assembly 110 rotates toward the case body 130, the electrode tabs 112 and 114 may be bent around at least one bend point BP. Thereafter, the case cover 140 may be coupled to the case body 130 in which the electrode assembly 110 is accommodated, thereby sealing the opening of the case body 130 (S830).

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

100: secondary battery
120: case
130: case body
140: case cover
150: first electrode terminal
160: second electrode terminal
180: electrolyte injection hole

What is claimed is:

1. A secondary battery comprising:
a case body having an opening formed therein;
an electrode assembly accommodated in the case body, the electrode assembly comprising a first electrode, a separator, and a second electrode; and
a case cover covering the opening of the case body,
wherein at least a portion of each of the case body and the case cover comprises a polymer layer comprising a resin material, and
a water vapor transmission rate of the polymer layer is less than or equal to 20 g/m²·day under conditions of 40° C. and 90% relative humidity.

2. The secondary battery as claimed in claim 1, wherein a dimethyl carbonate transmission rate of the polymer layer is less than or equal to 20 g/m²·day under conditions of 40° C.

3. The secondary battery as claimed in claim 1, wherein a density of the polymer layer is less than or equal to 1.5 g/cm³.

4. The secondary battery as claimed in claim 1, wherein a thickness of the polymer layer is 100 μm to 150 μm.

5. The secondary battery as claimed in claim 1, wherein at least a portion of the polymer layer comprises at least one of oriented polypropylene, cast polypropylene, cast polypropylene with aluminum deposition (CPP Al), polyetheretherketone, liquid crystal polymer, polytetrafluoroethylene, perfluoroalkoxy, fluorinated ethylene propylene, and polychlorotrifluoroethylene.

6. The secondary battery as claimed in claim 1, wherein the polymer layer comprises:
a first polymer layer facing the electrode assembly, and
a second polymer layer disposed on the first polymer layer and exposed externally.

7. The secondary battery as claimed in claim 6, wherein at least a portion of the first polymer layer comprises polypropylene, and
wherein at least a portion of the second polymer layer comprises at least one of polyetheretherketone, cast polypropylene with aluminum deposition, liquid crystal polymer, polytetrafluoroethylene, and polychlorotrifluoroethylene.

8. The secondary battery as claimed in claim 6, wherein 10 wt % to 20 wt % of the first polymer layer is an inorganic compound.

9. The secondary battery as claimed in claim 6, wherein the polymer layer further comprises a third polymer layer disposed between the first polymer layer and the second polymer layer.

10. The secondary battery as claimed in claim 9, wherein at least a portion of the first polymer layer comprises polypropylene,
at least a portion of the second polymer layer comprises at least one of polyetheretherketone and polyethylene terephthalate, and
at least a portion of the third polymer layer comprises polytetrafluoroethylene.

11. The secondary battery as claimed in claim 1, wherein an electrode terminal electrically connected to the first electrode protrudes from a side surface of the case body.

12. The secondary battery as claimed in claim 1, wherein the case body comprises a receiving portion in which the electrode assembly is accommodated and a flange portion that surrounds the receiving portion, and
wherein the case cover is disposed such that at least a portion of the case cover faces the flange portion of the case body.

13. A method of manufacturing a secondary battery, the method comprising:
providing an electrode assembly comprising a first electrode, a separator, and a second electrode;
providing a case body having an opening;
inserting the electrode assembly into the case body; and
coupling a case cover to the case body to cover the opening,
wherein at least a portion of each of the case body and the case cover comprises a polymer layer comprising a resin material, and
a water vapor transmission rate of the polymer layer is less than or equal to 20 g/m²·day under conditions of 40° C. and 90% relative humidity.

14. The method as claimed in claim 13, wherein a DMC transmission rate of the polymer layer is less than or equal to 20 g/m²·day under conditions of 40° C.

15. The method as claimed in claim 13, wherein a density of the polymer layer is less than or equal to 1.5 g/cm³.

16. The method as claimed in claim 13, wherein the polymer layer comprises:
a first polymer layer facing the electrode assembly, and
a second polymer layer disposed on the first polymer layer and exposed externally,
wherein at least a portion of the first polymer layer comprises polypropylene, and
at least a portion of the second polymer layer comprises at least one of polyetheretherketone, cast polypropylene with aluminum deposition, liquid crystal polymer, polytetrafluoroethylene, and polychlorotrifluoroethylene.

17. The method as claimed in claim 16, wherein 10 wt % to 20 wt % of the first polymer layer is an inorganic compound.

18. The method as claimed in claim 13, wherein an electrode terminal protrudes from a side surface of the case body, and
wherein the inserting comprises electrically connecting the first electrode to the electrode terminal.

19. The method as claimed in claim 13, wherein the case body comprises a receiving portion in which the electrode assembly is accommodated and a flange portion that surrounds the receiving portion, and
wherein the coupling comprises:
disposing at least a portion of the flange portion of the case body to face at least a portion of the case cover, and
coupling the case body and the case cover by thermal welding or laser welding.

20. The method as claimed in claim 19, wherein the case body is formed by vacuum forming or deep drawing.
